(19) United States
(12) Patent Application Publication
(10) Pub. No.: US 2006/0133105 A1
(43) Pub. Date: Jun. 22, 2006

(54) Remote controller having flash function

(76) Inventor: Dong-Ho Kim, Seoul (KR)

Correspondence Address: JORDAN AND HAMBURG LLP, 122 EAST 42ND STREET, SUITE 4000, NEW YORK, NY, 10168, US

(21) Appl. No.: 11/125,629

(22) Filed: May 10, 2005

(30) Foreign Application Priority Data
Dec. 3, 2004 (KR) 20-2004-0034386

(51) Int. Cl. F21V 33/00; G06F 1/16; H04N 5/44; G08C 19/00

(52) U.S. Cl. 362/577; 361/680; 340/825.72; 348/734

(57) ABSTRACT

A remote controller having a function for lighting up a dark place includes a hand generator and a condenser installed inside of a case and a rotating knob installed outside of the case thereby providing for making electricity by supplying the hand generator with a torque, the condenser being connected to the illuminating lamp and to a circuit substrate. The remote controller may be used semi-permanently without replacing a battery often unlike a conventional remote controller having a flash function, thereby greatly reducing use costs and greatly improving customer satisfaction and merchantability.

### CROSS-REFERENCE TO RELATED APPLICATIONS

This application claims benefit under 35 U.S.C. § 119 from Korean Utility Model Application No. 2004-34386, filed on Dec. 03, 2004, the entire content of which is incorporated herein by reference.

### BACKGROUND OF THE INVENTION

1. Field of the Invention

The present invention relates to a remote controller for controlling an electronic device from a distance, and more particularly, to a remote controller having a flash function for lighting up a dark place.

2. Description of the Related Art

Generally, a remote controller is for remote-controlling a variety of electronic devices, including a television, video tape recorder, audio equipment, air conditioner and so on. It is common that this remote controller has such a shape that has an infrared signal sending unit arranged on the front of a case having a circuit substrate embedded therein and a plurality of operating buttons arranged on the front surface thereof.

One can carry the remote controller conveniently because of its relatively small size, and turn on/off an electronic device or control channels, volume, power conveniently from a distance away. This remote controller is often kept in places, such as on a living room table, at a headboard, etc., because of its high frequency of use where one can easily find and get the remote controller.

While one is at home, they sometimes have to look for an article in their vicinity, when general lighting is put out. In this case, the job of turning on interior lighting, looking for the article and then turning off the interior lighting is very troublesome. Besides, when they might have to look for the article dropped in a dark place such as a corner, gap or the like, or look for an emergency lantern or candle at the time of an unexpected power failure, it is troublesome to move to the place where an emergency lantern or candle is kept, and get the emergency lighting.

Hereupon, a plurality of remote controllers having a flash function were proposed which enable to look for an article conveniently in the vicinity or make it easy to take measures necessary to the time of power failure by adding a flash function to a remote controller kept in a place where one can easily find and have it in hand (Korean Publication for Registered Utility Model No. 1992-4122, Registered Utility Model No. 210268, Registered Utility Model No. 339757).

Conventionally proposed remote controllers having a flash function have an illuminating lamp installed at one side of the front edge of a case where an infrared signal sending unit is arranged, and an illuminating lamp operating switch button arranged at the front surface or one side of the case, and thus they might be able to carry out the aforementioned emergency lighting function excellently. However, since the illuminating lamp is supplied with power from a replaceable battery supplying power to the circuit substrate embedded in the case, if the flash function is used, the consumption of the battery will be high, which leads to a problem that the primary function of the remote controller, that is, the infrared signal sending function cannot be carried out as well as the flash function unless the battery is replaced often.

### SUMMARY OF THE INVENTION

The present invention is devised in consideration of the above problem of the prior art, and it aims at providing a remote controller having a flash function, the remote controller provided with an illuminating lamp at one side of the front edge of a case, which enables to carry out an emergency lighting function for a longer period of time without replacement of a battery.

To achieve the above object, there is provided a remote controller having a flash function according to the present invention, characterized in that: a hand generator, generating by a rotating knob installed outside of a case, and a condenser are installed inside of the case, the condenser being connected to a circuit substrate and an illuminating lamp.

### BRIEF DESCRIPTION OF THE DRAWINGS

The above aspects and features of the present invention will be more apparent by describing certain embodiments of the present invention with reference to the accompanying drawings, in which:

### DETAILED DESCRIPTION OF THE PREFERRED EMBODIMENTS

Hereinafter, concrete technical contents of the present invention will be described in more detail with reference to the accompanying drawings.

That is to say,

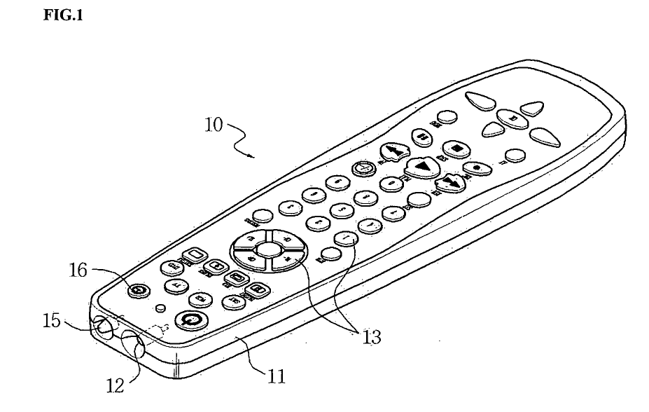

FIG. 1 illustrates a perspective view of one embodiment of the present invention.

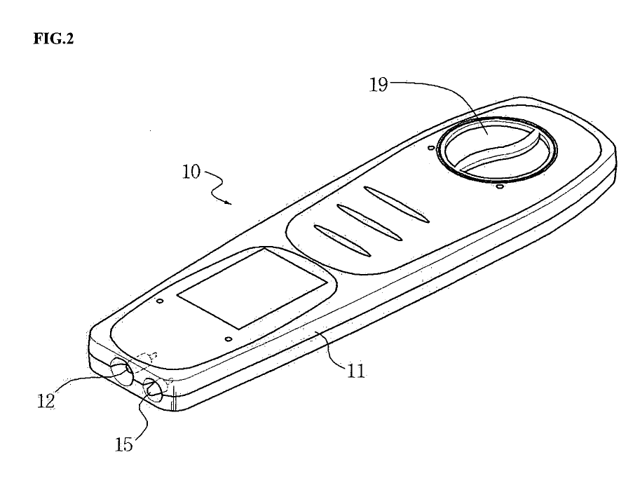

FIG. 2 illustrates a rear perspective view of the same embodiment.

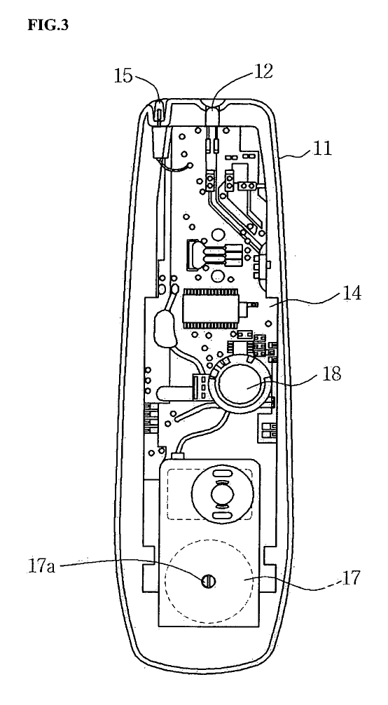

FIG. 3 illustrates a rear perspective view of the inside of a case of the same embodiment.

In the present invention, a remote controller 10 having a flash function, comprising an illuminating lamp 15 installed at one side of the front edge of a case 11 with an infrared signal sending unit 12, an illuminating lamp operating switch button 16 arranged at the front surface or one side of the case 11 where a plurality of operating buttons 13 are arranged, and a circuit substrate 14 installed inside of the case 11, comprises: a hand generator 17 and a condenser 18 installed inside of the case 11: and a rotating knob 19 installed outside of the case 11 for making electricity by supplying the hand generator 17 with a torque, the condenser 18 being connected to the illuminating lamp 15 and the circuit substrate 14.

In the illustrated embodiment, the hand generator 17 is installed at a lower part of the inside of the case 11, the rotating knob 19 is installed at a lower part of the rear surface of the case 11, and the illuminating lamp operating switch button 16 is installed at one upper side of the front surface of the case 11. Accordingly, it is to be understood that it is possible to change the installation positions of every components of the present invention into other expectable positions.

In the drawings, unexplained reference numeral 17a denotes a rotating knob coupling hole.

In the present invention constructed as set forth above, when the hand generator 17 is operated by rotating the rotating knob 18 installed outside of the case 11, electricity generated through the hand generator 17 is supplied and stored in the condenser 18, and the power of the condenser 18 is supplied to every single part of the circuit substrate 14 and to the illuminating lamp 15. During the process of using the infrared signal sending function and flash function of the remote controller 10, if the electricity condensed in the condenser 18 is all consumed, the hand generator 17 is operated through the rotating knob 19, thus being able to supply electricity to the condenser 18 again and store it therein. Thus it is possible to use the remote controller semi-permanently without replacing a battery often unlike the conventional ones.

As explained above, the remote controller of this invention comprises: a hand generator 17 and a condenser 18 installed inside of the case 11: and a rotating knob 19 installed outside of the case 11 for making electricity by supplying the hand generator 17 with a torque, the condenser 18 being connected to the illuminating lamp 15 and the circuit substrate 14. According to the present invention, it is possible to use the remote controller semi-permanently without replacing a battery often unlike a conventional remote controller having a flash function, thereby greatly reducing use costs and greatly improving customer satisfaction and merchantability.

1. (canceled)

2. In a remote controller having a flash function, the combination comprising a case having an illuminating lamp and a circuit unit, a hand generator and a condenser installed inside the case, and a rotating member installed outside the case for making electricity by supplying the hand generator with a torque, the condenser being connected to the illuminating lamp and the circuit unit.

3. In a remote controller according to claim 1, wherein the rotating member is a knob adapted to be rotated by a person using the remote controller.

4. In a remote controller according to claim 1, wherein rotation of the knob rotates the hand generator.

5. A remote controller having a flash function, comprising a case, an illuminating lamp and an infrared signal sending unit on said case, an illuminating lamp operating switch and a plurality of operating buttons on said case, a circuit substrate installed inside the case, a hand generator and a condenser installed inside the case, and a rotating knob installed outside the case for making electricity by supplying the hand generator with a torque, the condenser being connected to the illuminating lamp and the circuit substrate.

6. A remote controller having a flash function comprising a case, a lamp installed at one side of a front part of the case, an infrared signal sending unit on said case, an illuminating lamp operating a switch button arranged on one side of the case where a plurality of operating buttons are arranged, a circuit substrate inside of the case, a hand generator and a condenser inside the case, and a rotating knob installed outside of the case for making electricity by supplying the hand generator with a torque, the condenser being connected to the illuminating lamp and the circuit substrate.
